(19) United States
(12) Patent Application Publication
(10) Pub. No.: US 2009/0178319 A1
(43) Pub. Date: Jul. 16, 2009

(54) SIGN SUPPORT STRUCTURES

(76) Inventors: JOSE J. ULLOA, Avondale, AZ (US); Pauline R. Ulloa, Avondale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/405,683

(22) Filed: Mar. 17, 2009

Related U.S. Application Data
(62) Division of application No. 12/115,001, filed on May 5, 2008.
(60) Provisional application No. 60/934,547, filed on Jun. 14, 2007.

(51) Int. Cl. G09F 15/00

(52) U.S. Cl. 40/607.1

(57) ABSTRACT

A sign support structure includes a broad base plate having opposed upper and lower faces, and a perimeter edge. Substantially equally spaced-apart openings are formed through the base plate along the perimeter from the upper face to the lower face to receive stakes, respectively, to secure the base plate to the ground. A first elongate support has an upper end and an opposed lower end mounted to the base. The first elongate support extends upwardly from the upper face of the base to the upper end. A second elongate support has an inner end mounted to the first elongate support adjacent to the upper end of the first elongate support and extends laterally outward relative to the first elongate support to an outer end. The second elongate support is adapted to hold a real estate sign.

### CROSS-REFERENCE TO RELATED APPLICATION

This application claims the benefit of U.S. Provisional Patent Application Ser. No. 60/934,547, filed Jun. 14, 2007.

### FIELD OF THE INVENTION

The present invention relates to real estate sign support structures.

### BACKGROUND OF THE INVENTION

Real estate signs are often used to advertise the sale or lease of a particular piece of property. Typical real estate signs include a vertical post with a horizontal cross-arm which holds an advertising panel displaying information about the sale or lease. This information can include contact information such as the name of the person handling the lease or sale of the property. For effective advertising, the sign should be prominently displayed, readable from a distance, and should catch the prospective buyer or leaser's attention.

Typical real estate sign posts are simply driven into the ground, which is often quite difficult. Moreover, in many instances planting a real estate sign into the ground is simply not possible, or results in the real estate sign positioned at a location that is not optimized to effectively communicate the real estate sign to potential customers. Given these and other deficiencies in the art of real estate sign support structures, there is a continuing need in the art for improvement in real estate sign support structures.

### SUMMARY OF THE INVENTION

According to the principle of the invention, a sign support structure consists of an upstanding wall including an upper end and opposed substantially parallel first and second faces extending downwardly from either side of the upper end. Further to the present embodiment are a fixture, a first elongate support, and a second elongate support. The fixture includes a base having opposed first and second ends, opposed first and second sides extending between the opposed first and second ends, and opposed upper and lower faces, the first and second ends and the first and second sides cooperating to form a perimeter of the base. Opposed, substantially parallel first and second endwalls are affixed to the first and second ends, respectively, of the base. The first and second endwalls extend downwardly relative to the lower face of the base and each have an outer face and an opposed inner face. The inner faces of the first and second endwalls and the lower face of the base cooperate to form a receiving area of the fixture. A setting element is held by the first endwall. The wall is received in the receiving area, in which the upper end of the wall is received against the lower face of the base, the inner face of the first endwall confronts the first face of the wall, and the inner face of the second endwall confronts the second face of the wall. The setting element held by the first endwall is applied against the first face of the wall to urge the inner face of the second endwall against the second face of the wall to secure the fixture to the wall. The first elongate support has a lower end affixed to the fixture and extends upwardly relative to the upper face of the base of the fixture to an upper end. The second elongate support has an inner end mounted to the first elongate support adjacent to the upper end of the first elongate support and extends laterally outward from the first elongate support to an outer end. The second elongate support is adapted to hold a real estate sign. The lower end of the first elongate support is, in accordance with a preferred embodiment, affixed to the base of the fixture. The setting element has an abutment end located in the receiving area and is mounted to the first endwall for movement between a first position of the abutment toward the first endwall away from the second endwall and a second position away from the first endwall toward the second endwall. In accordance with the present embodiment, the setting element is disposed substantially in the second position of the abutment to apply the abutment against the first face of the wall to urge the inner face of the second endwall against the second face of the wall to secure the fixture to the wall. In a particular embodiment, the abutment of the setting element is adjustable between the first and second positions thereof in response to rotation of the setting element.

According to the invention, a sign support structure consists of a broad base plate having opposed upper and lower faces, and a perimeter edge. Substantially equally spaced-apart openings are formed through the base plate along the perimeter from the upper face to the lower face to receive stakes, respectively, to secure the base plate to the ground. A first elongate support has a lower end mounted to the base and extends upwardly from a substantially central location of the upper face of the base to an upper end. A second elongate support has an inner end mounted to the first elongate support adjacent to the upper end of the first elongate support and an opposed outer end. The second elongate support is adapted to hold a real estate sign. In accordance with the present embodiment, the second elongate support extends substantially laterally outward from the first elongate support to the outer end of the second elongate support. The inner end of the second elongate support is mounted to the first elongate support adjacent to the upper end thereof for reciprocal movement of the second elongate support between retracted and extended positions relative to the first elongate support. A locking assembly is provided to secure the inner end of the second elongate support to the first elongate support in the retracted position of the second elongate support, in the extended position of the second elongate support, and in at least one position between the retracted and extended positions of the second elongate support. In an alternate embodiment, the inner end of the second elongate support is mounted to the first elongate support adjacent to the upper end of the first elongate support for pivotal movement between a lowered position of the second elongate support juxtaposed and substantially parallel relative to the first elongate support and a raised position extending substantially laterally outward from the first elongate support to the outer end of the second elongate support. In this embodiment there is provided a locking assembly to secure the second elongate support in the raised position.

According to the principle of the invention, a sign support structure includes a broad base plate having opposed upper and lower faces, and a perimeter edge. Substantially equally spaced-apart openings are formed through the base plate along the perimeter extending from the upper face to the lower face to receive stakes, respectively, to secure the base plate to the ground. A first elongate support has a lower end mounted to the base and extends upwardly from a substantially central location of the upper face of the base to an upper end. A socket is formed in the first elongate support adjacent to the upper end of the first elongate support. A second elongate support has an inner end received by the socket and extends substantially laterally outward from the first elongate support to an outer end. The inner end of the second elongate support is movable in reciprocal directions in the socket to moving the second elongate support between retracted and extended positions relative to the first elongate support. The second elongate support is adapted to hold a real estate sign. A locking assembly is provided to secure the inner end of the second elongate support to the socket in the retracted position of the second elongate support, in the extended position of the second elongate support, and in at least one position between the retracted and extended positions of the second elongate support.

### BRIEF DESCRIPTION OF THE DRAWINGS

Referring to the drawings:

FIG. 1 is a perspective view of a sign support structure constructed and arranged in accordance with the principle of the invention;

FIG. 2 is a sectional view taken along line 2-2 of FIG. 1;

FIG. 3 is a perspective view of an alternate embodiment of a sign support structure constructed and arranged in accordance with principle of the invention and further illustrating a stake opposing an opening formed in a broad base plate of the sign support structure;

FIG. 4 is a side elevational view of the sign support structure of FIG. 3;

FIG. 5 is a perspective view of yet another alternate embodiment of a sign support structure constructed and arranged in accordance with principle of the invention and further illustrating a stake opposing an opening formed in a broad base plate of the sign support structure;

FIG. 6 is a side elevational view of the sign support structure of FIG. 3 illustrating stakes opposing openings formed in the broad base plate of the sign support structure;

FIG. 7 is a fragmented, partially-exploded perspective view of still another alternate embodiment of a sign support structure constructed and arranged in accordance with the principle of the invention and further illustrating a stake opposing an opening formed in a broad base plate of the sign support structure;

FIG. 8 is a side elevational view of the sign support structure of FIG. 7; and

FIG. 9 is a fragmented side elevational view of the sign support structure of FIG. 7 illustrating a sign supporting arm of the sign support structure shown as it would appear in a lowered position.

### DETAILED DESCRIPTION OF A PREFERRED EMBODIMENT

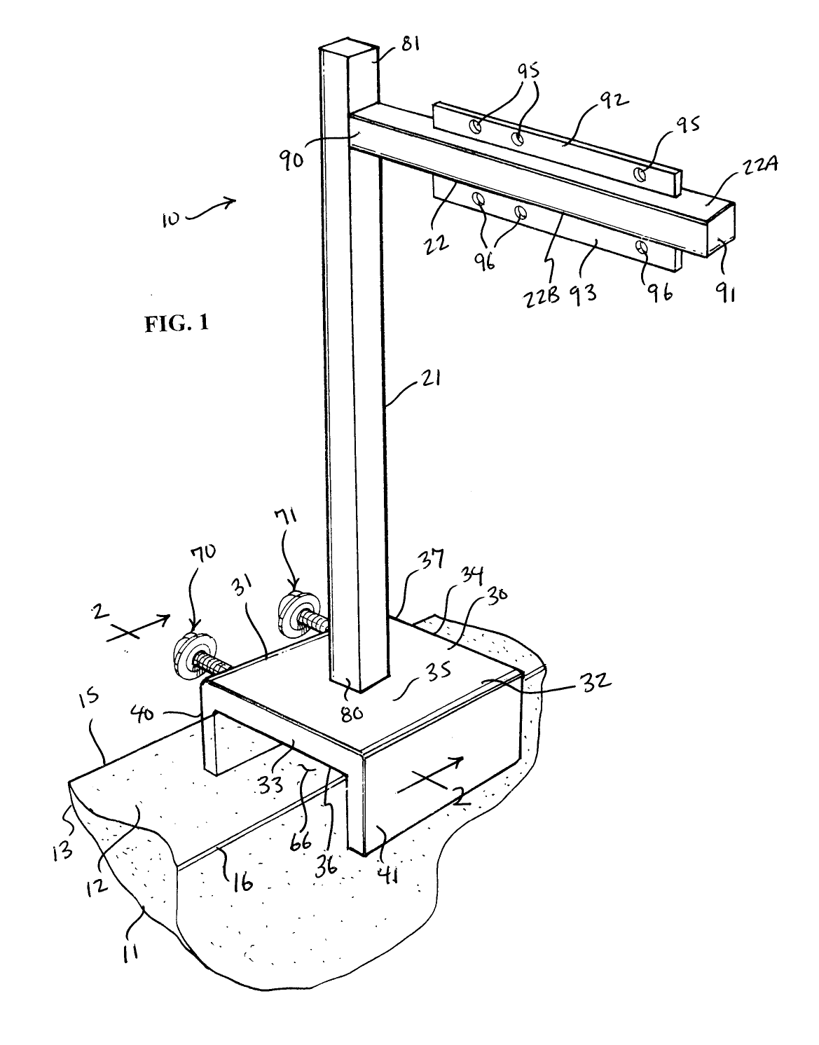

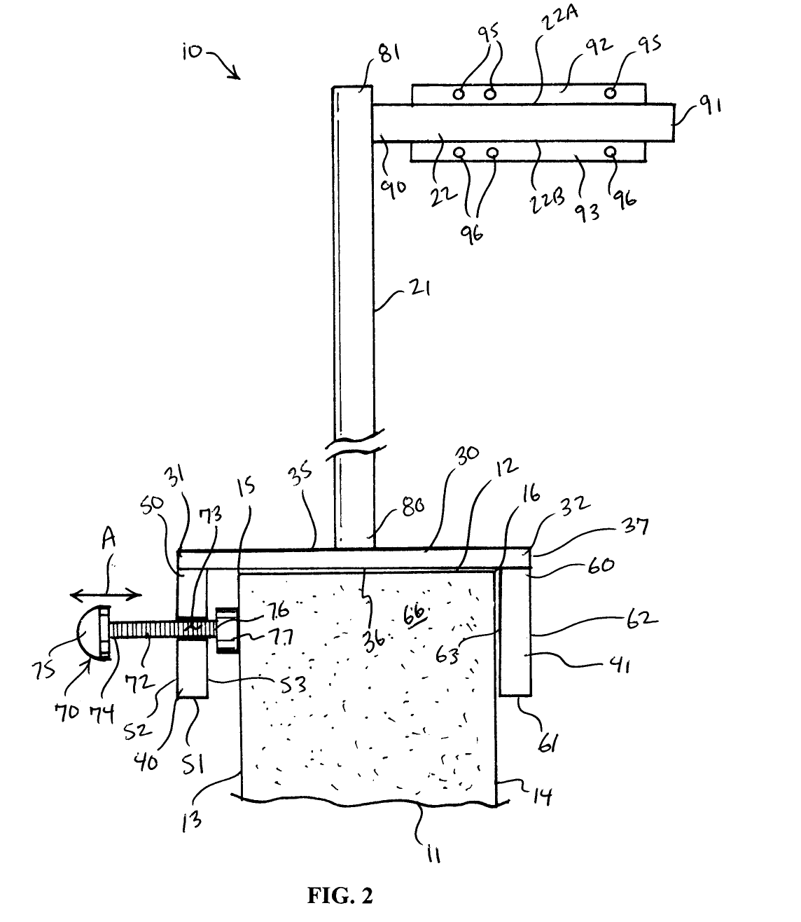

Turning now to the drawings, in which like reference characters indicate corresponding elements throughout the several views, attention is first directed to FIGS. 1 and 2 in which there is seen a sign support structure 10 in combination with an upstanding wall 11 including an upper end 12 and opposed substantially parallel first and second faces 13 and 14 extending downwardly from sides 15 and 16, respectively, of upper end 12. Sign support structure 10 consists of a fixture 20, a first elongate support 21, and a second elongate support 22. Sign support structure 10 is used to support a real estate sign, and is fashioned of steel, aluminum, plastic, or other substantially rigid material or combination of materials.

Fixture 20 includes a base 30, which is broad and flat and generally square in shape, has opposed first and second ends 31 and 32, opposed first and second sides 33 and 34, illustrated in FIG. 1, extending between the opposed first and second ends 31 and 32, and opposed upper and lower faces 35 and 36. Referencing FIG. 1, first and second ends 31 and 32 and first and second sides 33 and 34 cooperate to form a perimeter 37 of base 30. Opposed, substantially parallel first and second endwalls 40 and 41 are affixed to first and second ends 31 and 32, respectively, of base 30, and extend downwardly relative to lower face 36 of base 30.

More specifically, first endwall 40 is broad and flat and generally rectangular in shape. Referencing FIG. 2, first endwall 40 has an upper end 50 affixed, such as by welding, to first end 31 of base 30, and extends downwardly from first end 31 of base 30 relative to lower face 36 of base 30 to a lower end 51. First endwall 40 has an outer face 52 and an opposed inner face 53. Second endwall 41 is broad and flat and generally rectangular in shape and is substantially equal in size to first endwall 40. Second endwall 41 has an upper end 60 affixed, such as by welding, to second end 32 of base 30, and extends downwardly from second end 32 of base 30 relative to lower face 36 of base 30 to a lower end 61. Second endwall 41 has an outer face 62 and an opposed inner face 63.

First end second endwalls 40 and 41 are opposed and substantially parallel relative to one another. Inner face 53 of first endwall 40 opposes and is substantially parallel relative to inner face 63 of second endwall 41. Inner faces 53 and 63 of first and second endwalls 40 and 41 cooperate with lower face 36 of base 30 to form a receiving area 66 of fixture 20. Fixture 20 may be integrally formed, if desired.

Referencing FIG. 1, setting elements 70 and 71 are held by first endwall 40. Setting elements 70 and 71 are identical in every respect. As such, only the details of setting element 70 will be discussed, with the understanding that the ensuing discussion of setting element 70 applies in every respect to setting element 72.

Referencing FIG. 2, setting element 71 consists of an elongate threaded rod 72 threadeably received by a threaded opening 73 extending through first endwall 40 from outer face 52 to inner face 53 between upper and lower ends 50 and 51. Rod 72 has an outer end 74 formed with a handle 75, and an opposed inner end 76 formed with an abutment 77. Outer end 74 formed with handle 75 is located outboard of outer face 52 of first endwall 40, and inner end 76 formed with abutment 77 is located inboard of inner face 53 of first endwall 40 in receiving area 66 between inner face 53 of first endwall 40 and inner face 63 of second endwall 41. Rod 72 moves in reciprocal directions as indicated by the double arrowed line A in FIG. 2 in response to rotation thereof in clockwise and counterclockwise directions, which, in turn, moves abutment 77 in said reciprocal directions between a first or retracted position toward inner face 53 of first endwall 40 and away from inner face 63 of second endwall 41, and a second or extended position away from inner face 53 of first endwall 40 and toward inner face 63 of second endwall 41. Handle 75 formed on outer end 74 of rod 72 may be easily taken up by hand by a user for imparting rotation to rod 72 for adjusting abutment 77 between its retracted and extended positions.

In the preferred embodiment, two setting elements 70 and 71 are used, and are positioned side-by-side. However, less or more may be employed depending on specific needs according to the teachings provided by this disclosure.

According to the principle of the invention, wall 11 is received in receiving area 66 as illustrated in FIGS. 1 and 2, in which as seen in FIG. 2 upper end 12 of wall 11 is received against lower face 36 of base 30, inner face 53 of first endwall 40 confronts first face 13 of wall 11, and inner face 63 of second endwall 41 confronts second face 14 of wall 11. Setting element 70 held by first endwall 40 is adjusted disposing abutment 77 in its retracted position, and is thus located between inner face 53 of first endwall 40 and first face 13 of wall 11. To complete the installation of fixture 20 to wall 11, setting element 70 is adjusted to move abutment 77 toward its extended position to apply abutment 77 against first face 13 of wall 11 to urge inner face 63 of second endwall 41 against second face 14 of wall 11 to thereby clamp wall 11 in receiving area between abutment 77 and inner face 63 of second endwall 41 to secure fixture 20 to wall 11. Setting element 71 is adjusted like that of setting element 70 to, in turn with setting element 70, clamp fixture 20 to wall 11.

Referencing FIGS. 1 and 2, first elongate support 21 is of a predetermined length and has a lower end 80 affixed, such as by welding, to fixture 20 and extends upwardly relative to upper face 35 of base 30 of fixture 20 to an upper end 81. In this preferred embodiment, lower end 80 is affixed to upper face 35 of base 30 at a substantially central location. Lower end 80 of first elongate support 21 may be integrally formed with base 30, if desired. Second elongate support 22 has an inner end 90 mounted to first elongate support 21 adjacent to upper end 81 of first elongate support 21 and extends laterally outward from first elongate support 21 to an outer end 91. As clearly shown in FIGS. 1 and 2, second elongate support 22 is supported by first elongate support 21 substantially horizontally at an elevated location relative to fixture 20, is substantially perpendicular relative to first elongate support 21, and is substantially parallel relative to upper face 35 of base 30 of fixture 20. In this embodiment, inner end 90 of second elongate support 22 is rigidly affixed to first elongate support 21 adjacent to upper end 81 of first elongate support 21, such as by welding. If desired, inner end 90 of second elongate support 22 may be integrally formed with first elongate support 21.

Second elongate support 22 is of a predetermined length and is adapted to hold or otherwise support a real estate sign. To accomplish this in the present embodiment, second elongate support 22 has an upper side 22A formed with an elongate bracket or extension 92, and an opposed lower side 22B formed with an elongate bracket or extension 93. Elongate extension 92 is formed with openings 95 for receiving fasteners, such as bolts or screws or the like, to secure a real estate sign atop upper side 22A of second elongate support 22. Elongate extension 93 is, like extension 92, formed with openings 96 for receiving fasteners, such as bolts or screws or the like, or chains or cordage, hooks, or the like, to suspend from or otherwise secure a real estate sign from lower side 22B of second elongate support 22.

The provision of fixture 20 allows sign support structure 10 to be mounted and secured atop a wall, such as wall 11 to form an exemplary embodiment of the invention, so as to permit a real estate sign secured to second elongate support 22 to be prominently displayed. Wall 11 is exemplary of an outside wall, such as a barrier wall enclosing a yard or other area of a residence or property offered for sale or lease or rent. To remove sign support structure 10 from wall 11 one need only reverse the operation of installing fixture 20 to wall, in accordance with the principle of the invention.

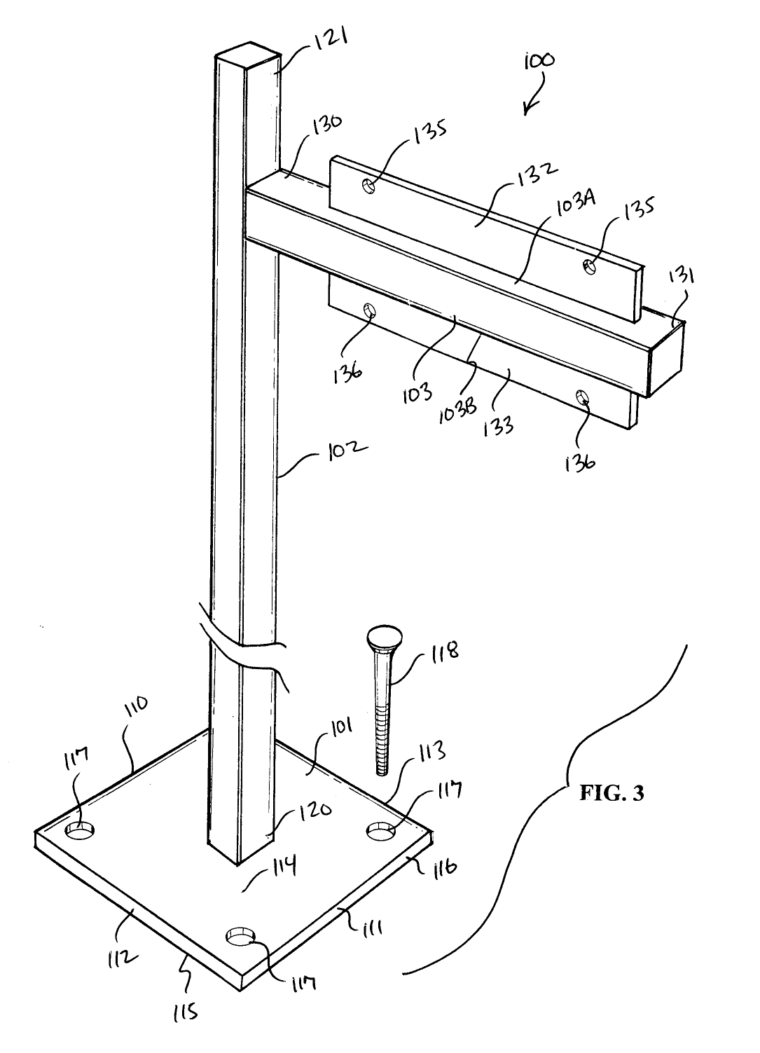

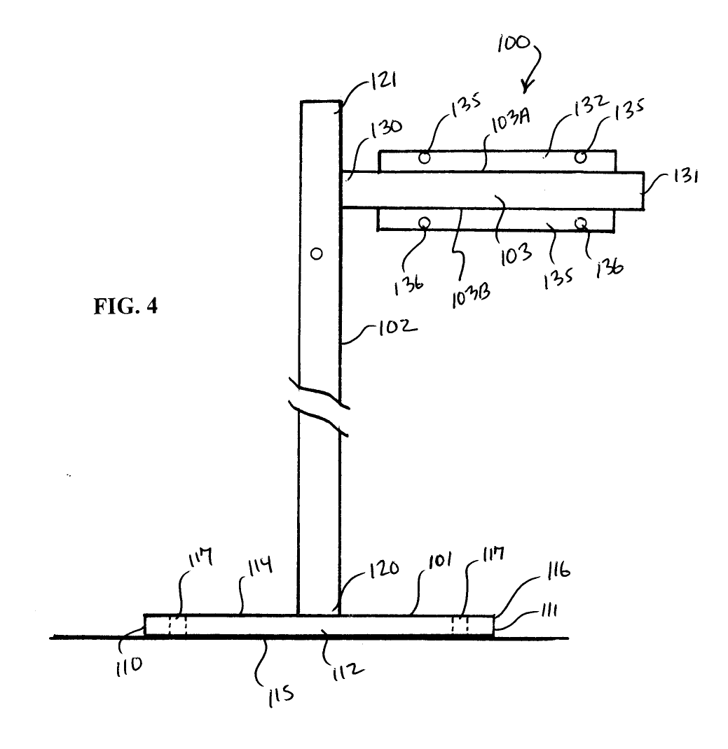

Reference is now made to FIGS. 3 and 4 in which there is illustrated an alternate embodiment of a sign support structure 100 including a base plate 101, a first elongate support 102, and a second elongate support 103. Sign support structure 100 is used to support a real estate sign, and is fashioned of steel, aluminum, plastic, or other substantially rigid material or combination of materials.

Referencing FIG. 3, base plate 101 is broad and flat and generally square in shape, has opposed, parallel first and second end edges 110 and 111, opposed, parallel first and second side edges 112 and 113 extending between the opposed first and second end edges 110 and 111, and opposed upper and lower faces 114 and 115. First and second end edges 110 and 111 and first and second side edges 112 and 113 cooperate to form a perimeter 116 of base plate 101. Substantially, equally spaced-apart openings 117 are formed through base plate 101 along perimeter 116 from upper face 114 to lower face 115, which receive stakes, respectively, such as stake 118, to secure base plate 101 to the ground, in accordance with the principle of the invention. In the present embodiment, base plate 101 is formed with four openings 117 each at one of the four corners of base plate 101 adjacent to perimeter 116, and less or more may be used to receive stakes to secure base plate 101, lower face 115 down, to the ground.

Referencing FIGS. 3 and 4, first elongate support 102 is of a predetermined length and has a lower end 120 affixed, such as by welding, to base plate 101 and extends upwardly relative to upper face 114 of base plate 101 to an upper end 121. In this preferred embodiment, lower end 120 is affixed to upper face 114 of base plate 101 at a substantially central location, whereby lower end 120 is encircled by openings 117 and perimeter 116. Lower end 120 of first elongate support 102 may be integrally formed with base plate 101, if desired.

Second elongate support 103 is of a predetermined length and has an inner end 130 mounted to first elongate support 102 adjacent to upper end 121 of first elongate support 103 and extends laterally outward from first elongate support 103 to an outer end 131. As clearly shown in FIGS. 3 and 4, second elongate support 103 is supported by first elongate support 102 substantially horizontally at an elevated location relative to base plate 101, is substantially perpendicular relative to first elongate support 102, and is substantially parallel relative to upper face 114 of base plate 101. In this embodiment, inner end 130 of second elongate support 103 is rigidly affixed to first elongate support 102 adjacent to upper end 121 of first elongate support 102, such as by welding. If desired, inner end 130 of second elongate support 103 may be integrally formed with first elongate support 102.

Second elongate support 103 is adapted to hold or otherwise support a real estate sign. To accomplish this in the present embodiment, second elongate support 103 has an upper side 103A formed with an elongate bracket or extension 132, and an opposed lower side 103B formed with an elongate bracket or extension 133. Elongate extension 132 is formed with openings 135 for receiving fasteners, such as bolts or screws or the like, to secure a real estate sign atop upper side 103A of second elongate support 103. Elongate extension 133 is, like extension 132, formed with openings 136 for receiving fasteners, such as bolts or screws or the like, or chains or cordage, hooks, or the like, to suspend from or otherwise secure a real estate sign from lower side 103B of second elongate support 103.

The provision of base plate 101 allows sign support structure 100 to be mounted and secured to the ground simply by placing base plate 101 lower face 115 down onto the ground and pounding or forcing stakes into the ground through openings 117. With base plate 101 so secured to the ground, first elongate support 102 extends upright therefrom to second elongate support 103 to form an exemplary embodiment of the invention, so as to permit a real estate sign secured to second elongate support 103 to be prominently displayed. To remove sign support structure 100, one need only reverse the operation of installing base plate 101 to the ground by removing the stakes from the ground and pulling them away from base plate 101.

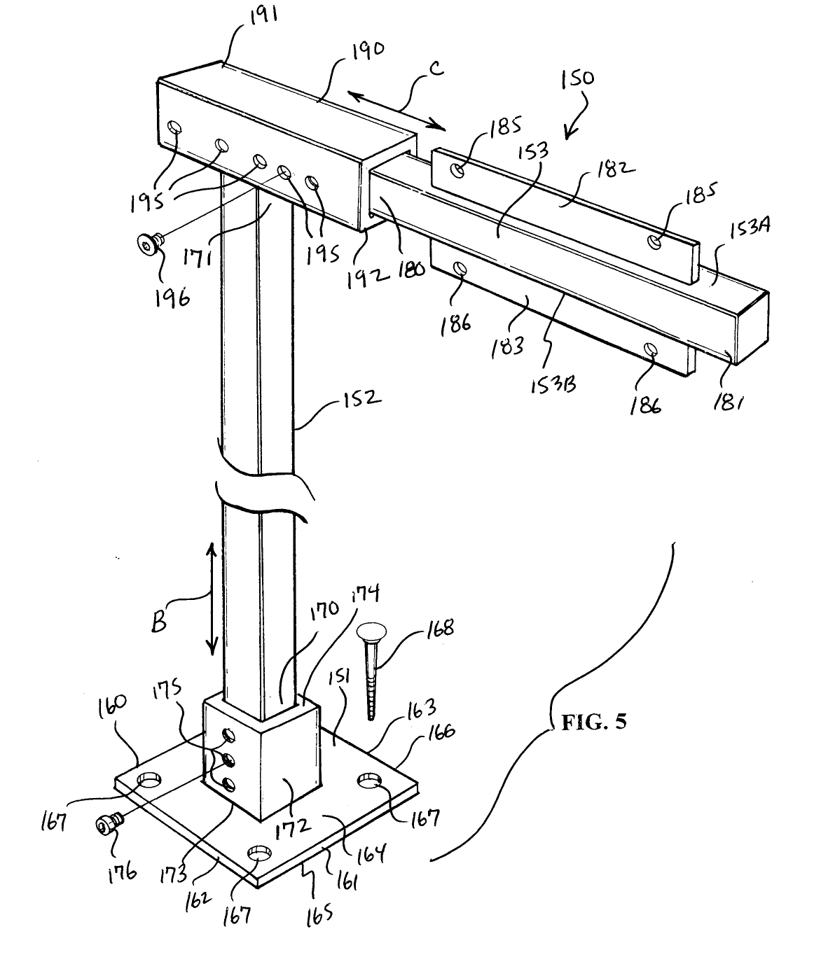

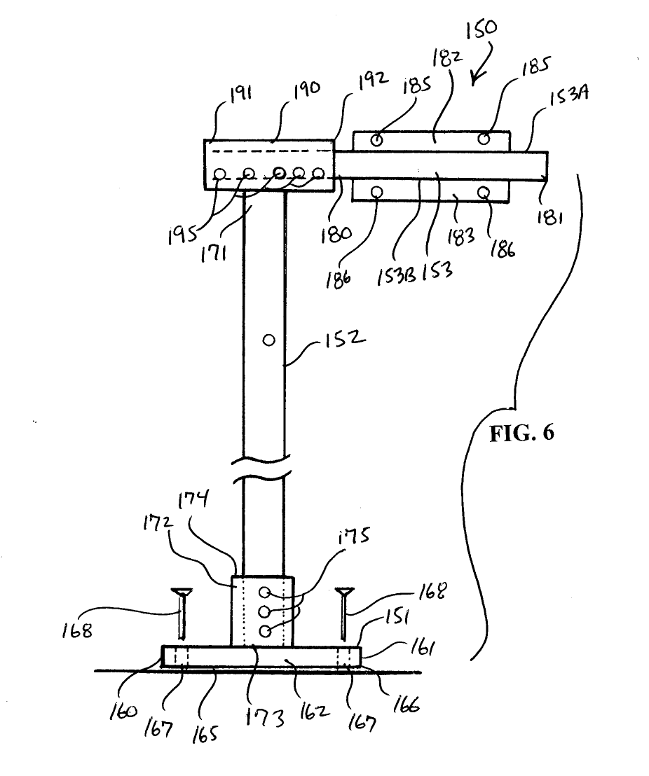

Reference is now made to FIGS. 5 and 6 in which there is illustrated an alternate embodiment of a sign support structure 150 including a base plate 151, a first elongate support 152, and a second elongate support 153. Sign support structure 150 is used to support a real estate sign, and is fashioned of steel, aluminum, plastic, or other substantially rigid material or combination of materials.

Referencing FIG. 5, base plate 151 is broad and flat and generally square in shape, has opposed, parallel first and second end edges 160 and 161, opposed, parallel first and second side edges 162 and 163 extending between the opposed first and second end edges 160 and 161, and opposed upper and lower faces 164 and 165. First and second end edges 160 and 161 and first and second side edges 162 and 163 cooperate to form a perimeter 166 of base plate 151. Substantially, equally spaced-apart openings 167 are formed through base plate 151 along perimeter 166 from upper face 164 to lower face 165, which receive stakes, respectively, such as stake 168, to secure base plate 151 to the ground, in accordance with the principle of the invention. In the present embodiment, base plate 151 is formed with four openings 167 each at one of the four corners of base plate 151 adjacent to perimeter 166, and less or more may be used to receive stakes to secure base plate 151, lower face 165 down, to the ground.

Referencing FIGS. 5 and 6, first elongate support 152 is of a predetermined length and has a lower end 170 affixed to base plate 151 and extends upwardly relative to upper face 164 of base plate 151 to an upper end 171. In this preferred embodiment, lower end 170 is affixed to upper face 164 of base plate 151 at a substantially central location, whereby lower end 170 is encircled by openings 167 and perimeter 166.

In the present embodiment, lower end 170 is received by an elongate socket 172 having a lower end 173 affixed to base plate 151, such as by welding or by integrally forming socket 172 with base plate 151, and an opposed upper end 174, which is open. Socket 172 is formed at a central location of upper face 164 of base plate 151 and extends upwardly from upper face 164 of base plate 151 from lower end 173 to upper end 174. Lower end 170 of first elongate support 152 is received in socket 172 through upper end 174, and is adjustable in reciprocal directions in socket 172 as indicated by the double arrowed line B between a lowered or retracted position toward upper face 164 of base plate 151 and a raised or extended position away from upper face 164 of base plate 151 thereby allowing the height of first elongate support 152 relative to upper face 164 of base plate 151 to be correspondingly adjusted. A locking assembly is provided, and is used to lock first elongate support 152 in its lowered position, its raised position, and in at least one position between its raised and lowered positions. In the present embodiment, the locking assembly consists of a series of threaded openings 175 extending through socket 172 from lower end 173 to upper end 174, and a threaded nut 176. After adjusting lower end 170 of first elongate support 152 in socket 172 to a specified location threaded nut 176 is threaded into one of the corresponding openings 175 and then tightened against the portion of lower end 170 of first elongate support 152 extending across such opening 175 thereby securing lower end 170 of first elongate support 152 to socket 172. In the present embodiment the locking assembly associated between socket 172 and lower end 170 of first elongate support 152 includes three openings 175, and more can be used, if desired.

Second elongate support 153 is of a predetermined length and has an inner end 180 mounted to first elongate support 152 adjacent to upper end 171 of first elongate support 152 and extends laterally outward from first elongate support 152 to an outer end 181. As clearly shown in FIGS. 3 and 4, second elongate support 153 is supported by first elongate support 152 substantially horizontally at an elevated location relative to base plate 151, is substantially perpendicular relative to first elongate support 152, and is substantially parallel relative to upper face 164 of base plate 151.

Second elongate support 153 is adapted to hold or otherwise support a real estate sign. To accomplish this in the present embodiment, second elongate support 153 has an upper side 153A formed with an elongate bracket or extension 182, and an opposed lower side 153B formed with an elongate bracket or extension 183. Elongate extension 182 is formed with openings 185 for receiving fasteners, such as bolts or screws or the like, to secure a real estate sign atop upper side 153A of second elongate support 153. Elongate extension 183 is, like extension 182, formed with openings 186 for receiving fasteners, such as bolts or screws or the like, or chains or cordage, hooks, or the like, to suspend from or otherwise secure a real estate sign from lower side 153B of second elongate support 153.

In this embodiment, inner end 180 of second elongate support 153 is mounted to first elongate support 152 adjacent to upper end 171 for reciprocal movement as indicated by the double arrowed line C in FIG. 5 between a first or retracted position of second elongate support 153 toward first elongate member 152 and a second or extended position away from first elongate member 152. In the present embodiment, inner end 180 of second elongate member 153 is received by an elongate socket 190 having a proximal end 191 formed in upper end 171 of first elongate support 152, and an opposed distal end 192, which is open. Socket 190 is substantially perpendicular relative to first elongate support 152. Inner end 180 of second elongate support 153 is received in socket 190 through distal end 192, and is adjustable in reciprocal directions in socket 172 as indicated by the double arrowed line C between the first or retracted position of second elongate support 153 and the second or extended position away from first elongate member 152 thereby allowing the length of second elongate support 153 relative to first elongate support 152 to be correspondingly adjusted.

A locking assembly is provided, and is used to lock second elongate support 153 in its retracted position, its extended position, and in at least one position between its retracted and extended positions. In the present embodiment, the locking assembly consists of a series of threaded openings 195 extending through socket 190 from proximal end 191 to distal end 192, and a threaded nut 196. After adjusting inner end 180 of second elongate support 153 in socket 190 to a specified location threaded nut 196 is threaded into one of the corresponding openings 195 and then tightened against the portion of inner end 180 of second elongate support 153 extending across such opening 195 thereby securing inner end 180 of second elongate support 153 to socket 190. In the present embodiment the locking assembly associated between socket 190 and inner end 180 of second elongate support 153 includes five openings 195, and less or more can be used, if desired.

The provision of base plate 151 allows sign support structure 150 to be mounted and secured to the ground simply by placing base plate 151 lower face 165 down onto the ground and pounding or forcing stakes into the ground through openings 167. With base plate 151 so secured to the ground, first elongate support 152 extends upright therefrom to second elongate support 153 to form an exemplary embodiment of the invention, so as to permit a real estate sign secured to second elongate support 153 to be prominently displayed. To remove sign support structure 150, one need only reverse the operation of installing base plate 151 to the ground by removing the stakes from the ground and pulling them away from base plate 151.

The reciprocal adjustability of first elongate support 152 between its lowered and raised positions and the provision of the locking assembly to lock first elongate support 152 in its lowered retracted position, its raised position, and in at least one position between its lowered position and its raised position permits a user to adjust second elongate support 153 at a predetermined height in order to support a real estate sign supported thereby at a specified height, in accordance with the principle of the invention.

The reciprocal adjustability of second elongate support 153 between its retracted and extended positions and the provision the locking assembly to lock second elongate support 153 in its retracted position, its extended position, and in at least one position between its retracted position and its extended position permits a user to adjust second elongate support 153 at a predetermined length relative to first elongate support 152 in order to allow second elongate support 153 to accommodate signs of varying width, in accordance with the principle of the invention, and also to locate a real estate sign at a specified location relative to first elongate support 152, in accordance with the principle of the invention.

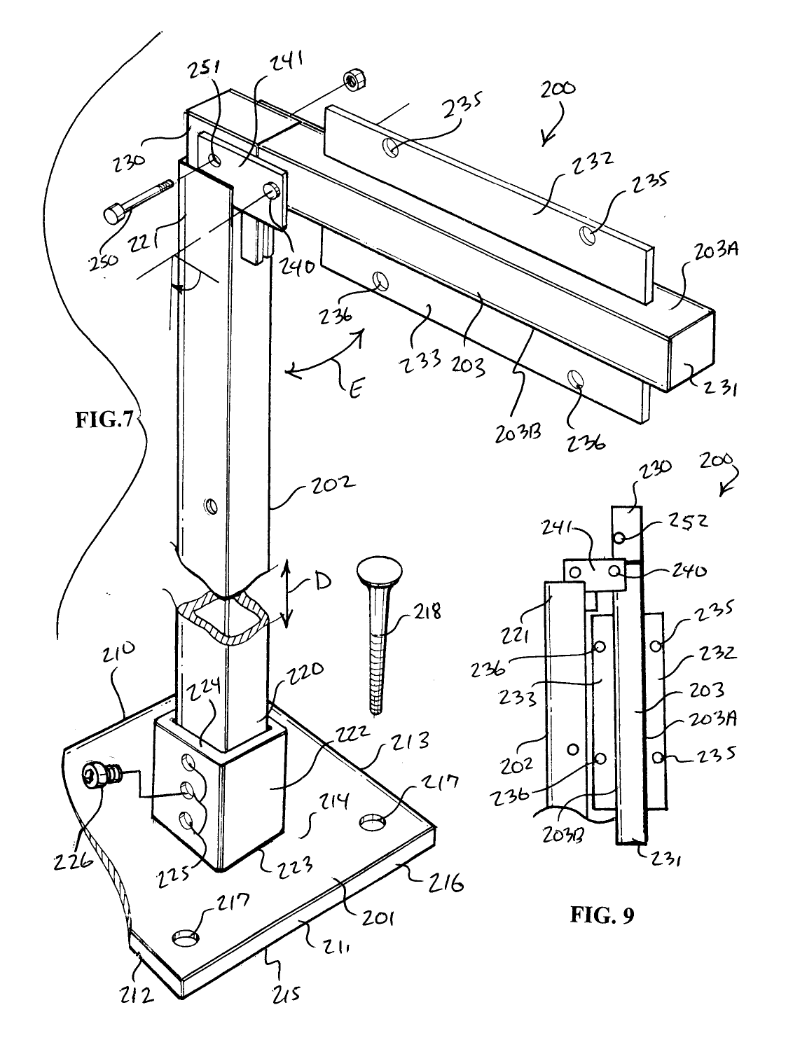

Reference is now made to FIGS. 7-9 in which there is illustrated an alternate embodiment of a sign support structure 200 including a base plate 201, a first elongate support 202, and a second elongate support 203. Sign support structure 200 is used to support a real estate sign, and is fashioned of steel, aluminum, plastic, or other substantially rigid material or combination of materials.

Referencing FIG. 7, base plate 201 is broad and flat and generally square in shape, has opposed, parallel first and second end edges 210 and 211, opposed, parallel first and second side edges 212 and 213 extending between the opposed first and second end edges 210 and 211, and opposed upper and lower faces 214 and 215. First and second end edges 210 and 211 and first and second side edges 212 and 213 cooperate to form a perimeter 216 of base plate 201. Substantially, equally spaced-apart openings 217 are formed through base plate 201 along perimeter 216 from upper face 214 to lower face 215, which receive stakes, respectively, such as stake 218, to secure base plate 201 to the ground, in accordance with the principle of the invention. In the present embodiment, base plate 201 is formed with four openings 217 each at one of the four corners of base plate 201 adjacent to perimeter 216, and less or more may be used to receive stakes to secure base plate 201, lower face 215 down, to the ground.

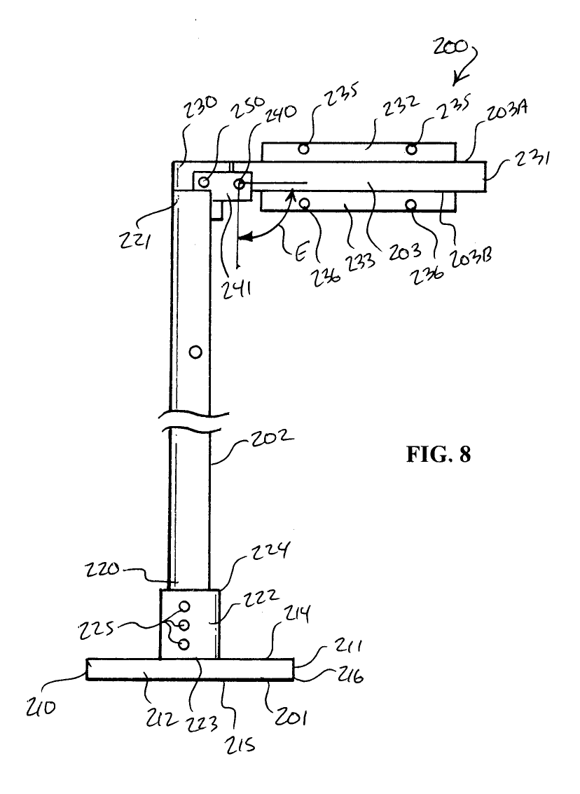

Referencing FIGS. 7 and 8, first elongate support 202 is of a predetermined length and has a lower end 220 affixed to base plate 201 and extends upwardly relative to upper face 214 of base plate 201 to an upper end 221. In this preferred embodiment, lower end 220 is affixed to upper face 214 of base plate 201 at a substantially central location, whereby lower end 220 is encircled by openings 217 and perimeter 216.

In the present embodiment, lower end 220 is received by an elongate socket 222 having a lower end 223 affixed to base plate 201, such as by welding or by integrally forming socket 222 with base plate 201, and an opposed upper end 224, which is open. Socket 222 is formed at a central location of upper face 214 of base plate 201 and extends upwardly from upper face 214 of base plate 201 from lower end 223 to upper end 224. Lower end 220 of first elongate support 202 is received in socket 222 through upper end 224, and is adjustable in reciprocal directions in socket 222 as indicated by the double arrowed line D between a lowered or retracted position toward upper face 214 of base plate 201 and a raised or extended position away from upper face 214 of base plate 201 thereby allowing the height of first elongate support 202 relative to upper face 214 of base plate 201 to be correspondingly adjusted. A locking assembly is provided, and is used to lock first elongate support 202 in its lowered position, its raised position, and in at least one position between its raised and lowered positions. In the present embodiment, the locking assembly consists of a series of threaded openings 225 extending through socket 222 from lower end 223 to upper end 224, and a threaded nut 226. After adjusting lower end 220 of first elongate support 202 in socket 222 to a specified location threaded nut 226 is threaded into one of the corresponding openings 225 and then tightened against the portion of lower end 220 of first elongate support 202 extending across such opening 225 thereby securing lower end 220 of first elongate support 202 to socket 222. In the present embodiment the locking assembly associated between socket 222 and lower end 220 of first elongate support 202 includes three openings 225, and more can be used, if desired.

Second elongate support 203 is of a predetermined length and has an inner end 230 mounted to first elongate support 202 adjacent to upper end 221 of first elongate support 202 and an opposed outer end 231. Second elongate support 203 is adapted to hold or otherwise support a real estate sign. To accomplish this in the present embodiment, second elongate support 203 has an upper side 203A formed with an elongate bracket or extension 232, and an opposed lower side 203B formed with an elongate bracket or extension 233. Elongate extension 232 is formed with openings 235 for receiving fasteners, such as bolts or screws or the like, to secure a real estate sign atop upper side 203A of second elongate support 203. Elongate extension 233 is, like extension 232, formed with openings 236 for receiving fasteners, such as bolts or screws or the like, or chains or cordage, hooks, or the like, to suspend from or otherwise secure a real estate sign from lower side 203B of second elongate support 203.

In this embodiment, inner end 230 of second elongate support 203 is mounted to first elongate support 202 adjacent to upper end 221 for pivotal movement as indicated by the arcuate double arrowed line E in FIGS. 7 and 8 between a lowered position of second elongate support 203 illustrated in FIG. 9 juxtaposed and substantially parallel relative to first elongate support 202 and a raised position of second elongate support 203 illustrated in FIGS. 7 and 8 extending substantially laterally outward from first elongate support 202 to outer end 231 of second elongate support 203. As clearly shown in FIGS. 7 and 8, in the raised position of second elongate support 203 is supported by first elongate support 202 substantially horizontally at an elevated location relative to base plate 201, is substantially perpendicular relative to first elongate support 202, and is substantially parallel relative to upper face 214 of base plate 201.

In the present embodiment as illustrated in FIG. 7, the pivotal attachment between second elongate support 203 and first elongate support 202 is provided by a pivot pin 240 received currently by a bracket 241 formed in upper end 221 of first elongate support and second elongate support 203 proximate to inner end 230 of second elongate support 203 between inner and outer ends 230 and 231 of second elongate support 203 as illustrated. Second elongate support 203 pivots about pivot pin 240 between its lowered position illustrated in FIG. 9 and its raised position illustrated in FIGS. 7 and 8. A locking assembly is provided, and is used to lock second elongate support 203 in its raised position. In the present embodiment, the locking assembly consists of a locking pin 250, an opening 251 formed in bracket 241, and an opening 252 illustrated in FIG. 9 formed in second elongate support 203 between pivot pin 240 and inner end 230 of second elongate support 203. In the raised position of second elongate support 203, opening 252 formed in second elongate support 203 registers with opening 251 formed in bracket 241. To lock second elongate support 203 in its raised position, locking pin 250 need only be taken up and passed concurrently into and through openings 251 and 252 thereby pining second elongate support 203 in its raised position, in accordance with the principle of the invention.

The provision of base plate 201 allows sign support structure 200 to be mounted and secured to the ground simply by placing base plate 201 lower face 215 down onto the ground and pounding or forcing stakes into the ground through openings 217. With base plate 201 so secured to the ground, first elongate support 202 extends upright therefrom to second elongate support 203 to form an exemplary embodiment of the invention, so as to permit a real estate sign secured to second elongate support 203 to be prominently displayed in the raised position of second elongate support 203. To remove sign support structure 200, one need only reverse the operation of installing base plate 201 to the ground by removing the stakes from the ground and pulling them away from base plate 201.

The reciprocal adjustability of first elongate support 202 between its lowered and raised positions and the provision of the locking assembly to lock first elongate support 202 in its lowered retracted position, its raised position, and in at least one position between its lowered position and its raised position permits a user to adjust second elongate support 203 at a predetermined height in order to support a real estate sign supported thereby at a specified height, in accordance with the principle of the invention.

The pivotal adjustability of second elongate support 203 between its lowered and raised positions and the provision the locking assembly to lock second elongate support 203 in its raised position permits a user to lock second elongate support 203 in its raised position as illustrated in FIGS. 7 and 8 during periods of use in supporting a real estate sign and then unlock second elongate support 203 from its raised position and pivot second elongate support 203 into its lowered position as illustrated in FIG. 9 during periods of nonuse and storage, in accordance with the principle of the invention.

The present invention is described above with reference to preferred embodiments. However, those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A sign support structure, comprising:
an upstanding wall including an upper end and opposed substantially parallel first and second faces extending downwardly from either side of the upper end;
a fixture, comprising:
a base having opposed first and second ends, opposed first and second sides extending between the opposed first and second ends, and opposed upper and lower faces, the first and second ends and the first and second sides cooperating to form a perimeter of the base;
opposed, substantially parallel first and second endwalls affixed to the first and second ends, respectively, of the base, the first and second endwalls extending downwardly relative to the lower face of the base and each having an outer face and an opposed inner face;
the inner faces of the first and second endwalls and the lower face of the base cooperating to form a receiving area of the fixture; and
a setting element held by the first endwall;
the wall received in the receiving area, in which the upper end of the wall is received against the lower face of the base, the inner face of the first endwall confronts the first face of the wall, and the inner face of the second endwall confronts the second face of the wall;
the setting element held by the first endwall applied against the first face of the wall to urge the inner face of the second endwall against the second face of the wall to secure the fixture to the wall;
a first elongate support having a lower end affixed to the fixture and extending upwardly relative to the upper face of the base of the fixture to an upper end;
a second elongate support having an inner end mounted to the first elongate support adjacent to the upper end of the first elongate support and extending laterally outward from the first elongate support to an outer end; and
the second elongate support adapted to hold a real estate sign.

2. The sign support structure according to claim 1, wherein the lower end of the first elongate support is affixed to the base of the fixture.

3. The sign support structure according to claim 2, further comprising:
the setting element has an abutment end located in the receiving area and is mounted to the first endwall for movement between a first position of the abutment toward the first endwall away from the second endwall and a second position away from the first endwall toward the second endwall; and
the setting element disposed substantially in the second position of the abutment to apply the abutment against the first face of the wall to urge the inner face of the second endwall against the second face of the wall to secure the fixture to the wall.

4. The sign support structure according to claim 3, wherein the abutment of the setting element is adjustable between the first and second positions thereof in response to rotation of the setting element.

5-11. (canceled)

12. A sign support structure, comprising:
an upstanding wall including an upper end;
a fixture formed with a receiving area and a setting element;
the upper end of the wall received in the receiving area formed in the fixture;
the setting element applied between the fixture and the wall to secure the fixture to the wall;
a first elongate support having a lower end attached to the fixture and extending upwardly with respect to the fixture and the upper end of the wall;
a second elongate support having an inner end mounted to the first elongate support adjacent to the upper end of the first elongate support and extending laterally outward from the first elongate support to an outer end; and
the second elongate support adapted to hold a real estate sign.

13. The sign support structure according to claim 12, further comprising:
the setting element has an abutment end located in the receiving area and is mounted to fixture for movement between a first position of the abutment away from the wall and a second position against the wall; and
the setting element set in the second position against the wall to secure the fixture to the wall.

14. The sign support structure according to claim 13, further comprising the setting element adjustable between the first and second positions thereof in response to rotation of the setting element.

15. A method comprising steps of:
providing an upstanding wall including an upper end;
providing a first elongate support having a lower end attached to a fixture and extending upwardly with respect to the fixture, and a second elongate support having an inner end mounted to the first elongate support adjacent to the upper end of the first elongate support and extending laterally outward from the first elongate support to an outer end, the second elongate support adapted to hold a real estate sign;
securing the fixture to the upper end of the wall; and
a first elongate support extending upwardly with respect to the upper end of the wall to the second elongate support extending laterally outward from the first elongate support.

16. The method according to claim 15, wherein the step of securing the fixture to the upper end of the wall comprises applying a setting element between the fixture and the wall to secure the fixture to the wall.
